(19) United States
(12) Patent Application Publication
(10) Pub. No.: US 2005/0015997 A1
(43) Pub. Date: Jan. 27, 2005

(54) Trimmer glove

(76) Inventor: Luis Alvaro Roble, Los Angeles, CA (US)

Correspondence Address: Luis Alvaro Roble, 1033 1/2 Meadowbrook Avenue, Los Angeles, CA, 90019, US

(21) Appl. No.: 10/624,972

(22) Filed: Jul. 22, 2003

(51) Int. Cl. B26B 13/00

(52) U.S. Cl. 30/232; 30/341; 30/537

(57) ABSTRACT

A trimmer glove (19) designed for providing comfort against the heat created by the tool, the hair clipper (15&17), while in use on a haircut. Made of neoprene (19) the user can slip the clipper/trimmer into the glove and easily access on/off switch (16), and the power cord (18) through a hole in the bottom of the trimmer glove (22) to be plugged into any electrical outlet and offer protection to the hand against the heat of the hair clipper (15&17) without disturbing the haircutting process.

### FEDERALLY SPONSORED RESEARCH

Not Applicable

### SEQUENCE LISTING OR PROGRAM

Not Applicable

### BACKGROUND

1. Field of Invention

This invention relates to the necessary protection from heat produced while using hair trimmers, specifically electric trimmers utilized in barbershops or salons in the employment of cutting hair.

2. Description of No Prior Art

Many barbers and hair stylists have experienced discomfort while attempting to style a patrons hair from the heat generated by the use of electric hair clippers. Currently, there is no known product, on the market, that alleviates this heat-oriented discomfort. Most barbers and hair stylists tend to use common household products such as duct tape or cotton socks until the heat becomes unbearable and causes cessation in the hair cutting procedure.

The delay in the hair cutting process often causes the patron to become upset or dissatisfied with the service. The customer's dissatisfaction ultimately results in a loss of patronage and income to both the barbershop/salon or barber/hair stylist in that the customer either tips low or does not return. Also, the efficiency of the barber/hairstylist is jeopardized because when the clippers become too hot time is wasted on cooling and this delay ultimately limits the number of successful cuts the barber/hairstylist can perform within a reasonable amount of time. Very often, barbers and hairstylists are forced to purchase and maintain two separate sets of clippers in order to uphold efficiency and preserve the patron's satisfaction.

Utilization of duct tape or socks appear very unprofessional and afford negative consequences. The glue on the tape has the tendency to melt and ooze out from underneath to become sticky and messy on the barber or stylist's hands which must remain constantly sanitized. The sock carries an unprofessional appearance as well as perceived hazardous conditions because the sock traps small particles of hair. In contrast, a specialized sleeve for the clippers offers a solution to the problem of overheating, a neat and professional appearance, as well as a diminished attraction for hair particles.

### OBJECTS AND ADVANTAGES

Accordingly, in lieu of the fact that at this time, no solution exists on the market to absorb or repel the heat created by the electric clipper, my patent as described above has other advantages, which are as follows:
a) To provide a product that incorporates utility with fashion that supports the ambiance of barbershop or salon.
b) To provide a convenient, inexpensive and easy to use solution to the problem of overheating hair clippers.
c) To provide a product that is both lightweight and washable.
d) To provide a product that effectively repels hair and diminishes dangerous conditions.
e) To provide a product that has a professional appearance and sleek design.
f) To provide a product that is made in a variety of colors and has the potential to make any barbershop or salon's decor.

Finally, a sophisticated product will enter the market for which there is great need to resolve an age-old problem in the hair cutting and styling industry.

### SUMMARY

In accordance with the present invention, a sleeve for the hair clipper effectively repels heat, comprises a lightweight body with openings for easy insertion and access for the electric cord and blades along with a cut out in the top allowing accessibility to the off/on switch.

### DRAWINGS

FIG. 1 is a perspective right-side view of a clipper covered in the glove in accordance with the invention, showing the right side of the glove.

FIG. 2 is a perspective left side of the clipper an glove.

FIG. 3 is a rotated perspective underside right view of the clipper and glove, exposing the machine-sewn seam.

FIG. 4 is a rotated perspective underside left view of the clipper and glove, exposing the machine-sewn seam.

FIG. 5 is a top view perspective of the hair clipper/trimmer and shows the blade of the hair trimmer along with the machine-sewn seam.

FIG. 6 is a bottom view perspective that displays the hair clipper/trimmer, power cord and on/off switch.

### REFERENCE NUMERALS IN DRAWINGS

15 electric hair clipper/trimmer
16 clipper on/off switch
17 bottom of hair clipper/trimmer
18 electric cord
19 neoprene casing, product TRIMMER GLOVE
20 on/off switch hole
21 TRIMMER GLOVE, top opening
22 TRIMMER GLOVE, bottom opening
23 Machine sewn seam

### DETAILED DESCRIPTION

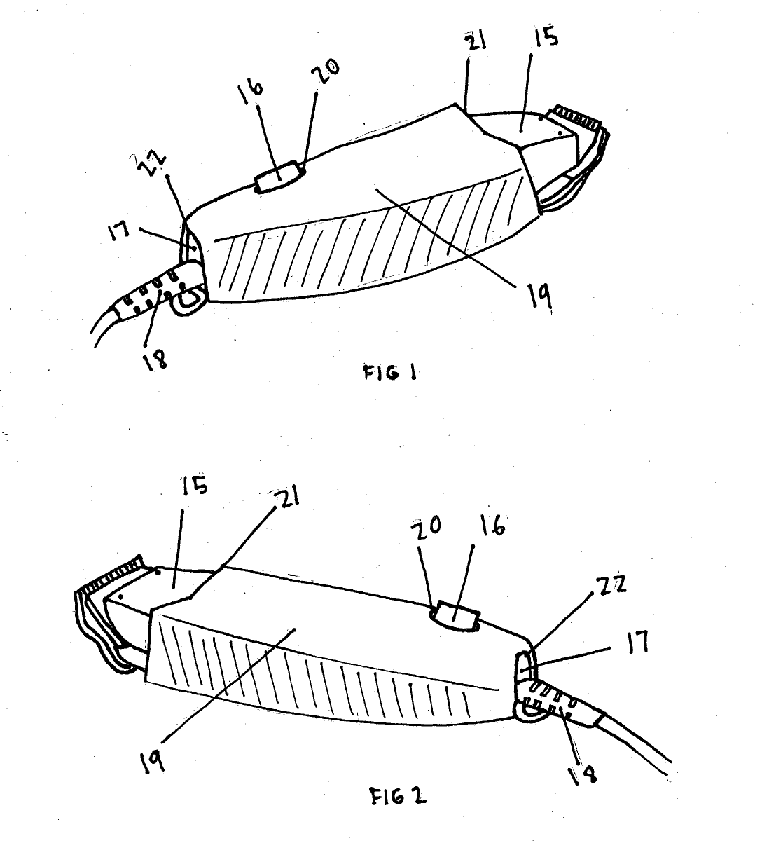

FIG. 1 is a perspective view taken from the user's right side of a hair cutting tool called an electric clipper also known as a hair trimmer 15 as manufactured by a hair clipper manufacturing company and covered in a neoprene casing 19, namely the trimmer glove. The trimmer glove has three openings, the top 21 to expose the blade, the bottom 22 to allow the electrical cord 18 to extend from the bottom of the clipper 17 to an outlet (not shown), and a hole 20 to expose the on/off switch 16, this hole is not passable for entering or exiting as openings 21 and 22.

FIG. 2 is the hair-cutting tool called a trimmer from the left perspective. The details are the same in this drawing as it mimics FIG. 1 from an opposing perspective whereas the clipper 15 is continually covered in a neoprene casing 19, namely the trimmer glove. The trimmer glove has three openings, the top 21 to expose the blade, the bottom 22 to allow the electrical cord 18 to extend from the bottom of the clipper 17 to an outlet (not shown), and a hole 20 to expose the on/off switch 16, this hole is not passable for entering or exiting as openings 21 and 22.

FIG. 3 is a rotated perspective underside view from the user's right side. The trimmer glove 19 is made of the material neoprene. The view exhibits the two openings, the top 21 and bottom 22. The top of the trimmer 15 and the bottom of the trimmer 17 are accessible and exposed through these two holes so that the trimmer head and blade 15 and trimmer cord18 are able to be of use. The underside of the trimmer glove 19 shows a seam 23 that allows for a tight fit.

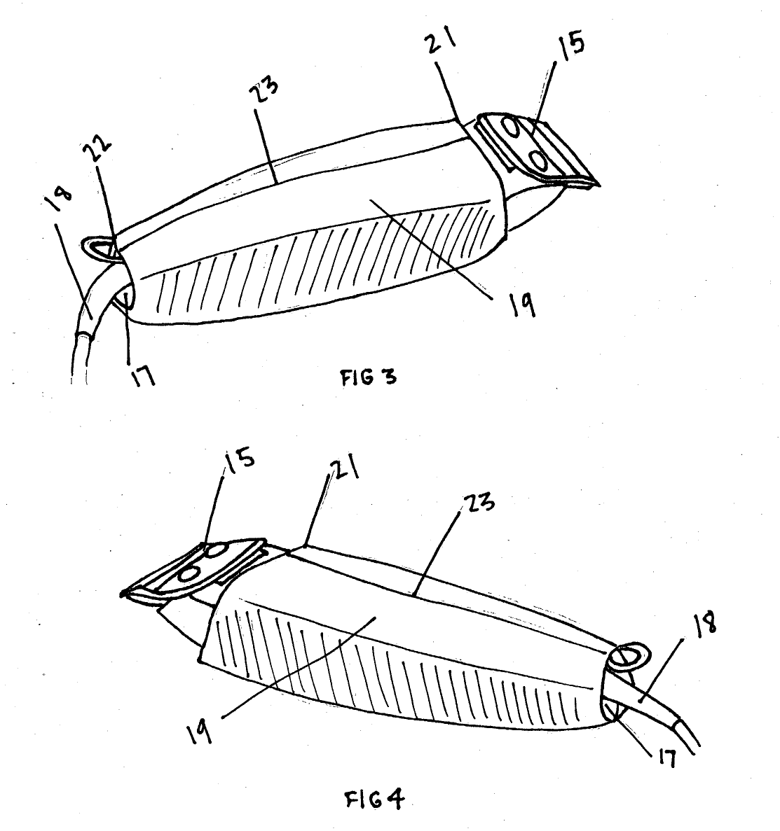

FIG. 4 is a rotated perspective underside view from the user's left side. The trimmer glove 19 is made of the material neoprene. The view exhibits the two openings, the top 21 and bottom 22. The top of the trimmer 15 and the bottom of the trimmer 17 are accessible and exposed through these two holes so that the trimmer head and blade 15 and trimmer cord18 are able to be of use. The underside of the trimmer glove 19 shows a seam 23 that allows for a tight fit.

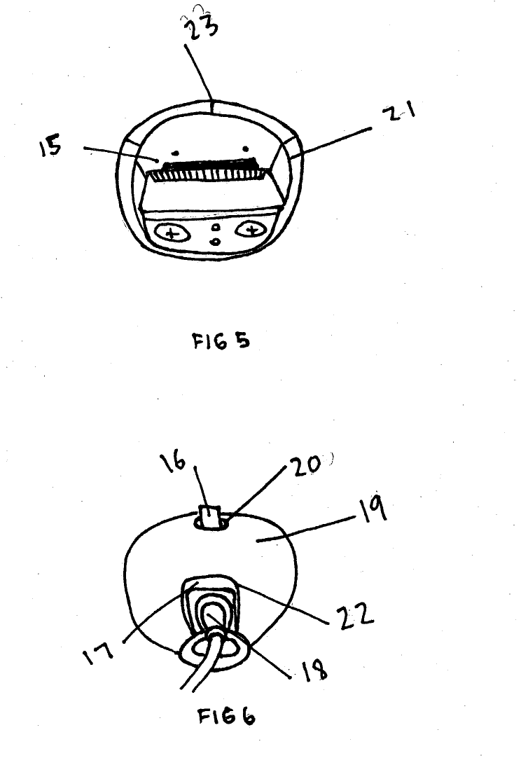

FIG. 5 is the perspective view taken from the top side of the hair clipper/trimmer 15 and shows the trimmer glove's machine sewn 23. From this view, the blade of the hair clipper is also shown.

FIG. 6 is the perspective view of the bottom of the hair clipper/trimmer 17 and displays the bottom opening of the trimmer glove 22. The hair clipper's electric power cord 18 is exposed and easily accessible extending outward for the purpose of plugging the cord into an electric power outlet (not shown). The trimmer glove 19, made of neoprene, has an additional hole cut out 20 that gives access to the on/off switch 16.

Advantages

The above description makes apparent the advantages of the product, for example:
(a) The hair clipper sleeve is specifically designed to fit a common hair trimmer.
(b) One of the openings of the trimmer affords easy unobstructed access to the on/off switch.
(c) The top opening leaves approximately one inch of space between the blade and the neoprene sleeve enabling used or dull blades to be replaced by new ones without removing the sleeve.
(d) The geometric dip at the top of the clipper, a shape of three-fourths of a quadrilateral, gives visibility for the electric clipper's logo or brand name.
(e) The bottom opening is wide enough to accommodate any sized cord.
(f) The material, in particular shark skin neoprene, offers a non-stick grip as the fabric is used with the rubber texture internally and the nylon texture externally.
(g) The thickness of the fabric absorbs the heat of the electric trimmer and also contributes to the sense of a firm grip and balance of the tool; this feature also establishes more control of the tool.
(h) The variety of colors brings personality to the tool and enhances its creative aspect.
   Operations

In operation one installs the sleeve on the electric hair clipper by first inserting the electric cord through both the top and bottom openings and pulls the cord all the way through until the section of the cord that is attached to the clipper is completely visible. Then the electric clipper itself is easily massaged through the sleeve until the bottom of the electric clipper is perfectly lined up with the bottom of the sleeve. One uses the glove in a manner which offers protection to the hands from the heat of the hair clipper, uncontrollably warming up from use and the small motor inside of the casing and carefully inserts the power cord into an electrical outlet, thus powering up the clipper for use on a haircut. The glove fits snugly and does not impede the haircutting process nor does it disturb the natural secure grip of the hair clipper in the haircutters hand. The user has access to the on/off switch and can easily manipulate the switch through the hole that gives access to that same switch.

Conclusion

The description, and drawings of my invention, make apparent the advantages and need for the product. The hair clipper sleeve is specifically designed to fit a common hair trimmer that is employed in most barbershops or salons. The three openings of the trimmer sleeve affords easy unobstructed access to the on/off switch, leaves approximately one inch of space between the blade and the neoprene sleeve enabling used or dull blades to be replaced by new ones without removing the sleeve, and accommodates the electric cord. The geometric dip at the top of the clipper, affords unobstructed advertising of the electric clipper. The bottom opening is wide enough to accommodate any sized cord. The material, in particular sharkskin neoprene, offers a non-stick grip as the fabric is used with the rubber texture internally and the nylon texture externally. And most importantly, the thickness of the fabric absorbs the heat of the electric trimmer and also contributes to the sense of a firm grip and balance of the tool; this feature also establishes more control of the tool. In addition, the variety of colors that will be offered, brings personality to the tool and enhances its creative aspect and the creativity of the barber or hair stylist. The many colors will also match any salon or barbershop's theme or decor. To sum it all up, this invention is simple, sleek, inexpensive and it works.

1. A cover for electric hair clippers and trimmers, comprised of a neoprene fabric casing to cover said electric hair clipper or trimmer tool that will prevent distraction or discomfort caused by the heating up of the hair clipper.

2. The specific type of neoprene is called sharkskin and this fabric is sewn together on one side to form a glove or sleeve.

3. The sharkskin neoprene has one side of rubber that is to be the inside of the glove or sleeve.

4. The glove or sleeve has three openings; one on top to expose the blade, one on bottom to expose the electric cord and one at the base to expose the on/off switch.

5. During the use of the clipper/trimmer, the user of said clipper/trimmer will be protected from the heat of the clipper/trimmer during a haircut.

6. The utilization of the glove or sleeve prevents interruption the haircut and does not sacrifice a safe and secure grip on the clipper/trimmer.

7. The glove or sleeve offers continuity and effective completion of the haircut without the need for interruption or the purchase of more than one of the same haircutting tool.

8. The glove or sleeve has a three quarter trapezoid cut out to expose the logo or brand name of the electric clipper that it surrounds.

9. The exterior nylon casing comes in a variety of colors.

10. The glove or sleeve incorporates one stitch up the backside to form the fabric in a cylindrical shape.
